(19) United States
(12) Patent Application Publication
(10) Pub. No.: US 2014/0152503 A1
(43) Pub. Date: Jun. 5, 2014

(54) DIRECTION OF ARRIVAL ESTIMATION USING LINEAR ARRAY

(71) Applicant: QUALCOMM INCORPORATED, San Diego, CA (US)

(72) Inventor: Boaz Castro, Tel Aviv (IL)

(73) Assignee: QUALCOMM Incorporated, San Diego, CA (US)

(21) Appl. No.: 13/692,925

(22) Filed: Dec. 3, 2012

(51) Int. Cl. G01S 3/28

(52) U.S. Cl. CPC G01S 3/28
USPC 342/432

(57) ABSTRACT

A linear array of sensors includes at least two omni-directional sensors and at least one directional sensor, with the axis of sensitivity of the directional sensor arranged, e.g., perpendicular to the linear axis of the linear array. The omni-directional sensors and directional sensor receive a signal and in response produce output signals. The direction of arrival of the received signal is estimated with a 360° range using the output signals of the omni-directional sensors and directional sensor. For example, two symmetric solutions for the direction of arrival of the received signal may be determined using the output signals of the omni-directional sensors, and the output signal from the directional sensor is used to determine the correct solution.

### BACKGROUND

1. Background Field

Embodiments of the subject matter described herein are related generally to estimating a direction of arrival of a signal, and more specifically to estimating a direction of arrival of a signal with a linear array.

2. Relevant Background

The direction of arrival (DOA) of a signal can be estimated based on the time of arrival at a plurality of sensors. By way of example, a directional microphone that includes multiple omni-directional sensors may be used to determine the DOA of acoustic signals from a source based on the difference in the time of arrival of the signal at the multiple omni-directional sensors. With a conventional single linear array of omni-directional sensors, however, the DOA is estimated with two possible solutions in a two-dimensional DOA case and, thus, provides an ambiguous result. In a three-dimensional DOA case, the resulting DOA estimate has more than two solutions.

FIG. 1, by way of example, illustrates a linear array 10 of omni-directional microphones 12 and 14 that is being used to estimate a far field DOA of a signal from a source S1. The delay in the time of arrival of the signal at microphones 12 and 14 may be used to estimate that the DOA of the signal from source S1 is at an angle α with respect to the linear array 10, as illustrated in FIG. 1. However, the same delay in the time of arrival of the signal at microphones 12 and 14 may also be caused by a signal originating source S2, which has a DOA of 180°—α with respect to the linear array 10, as illustrated in FIG. 1. Consequently, with a conventional single linear array 10, the measured DOA of a signal originating from source S1 results in two ambiguous results, a DOA of α and a DOA of 180°—α.

A conventional approach to eliminate the ambiguity in the DOA estimation uses two non-parallel linear arrays. For example, FIG. 2 illustrates two non-parallel linear arrays 10 and 20, which may be used to unambiguously estimate the DOA of a signal originating from source S1. Linear array 10, which as discussed in FIG. 1, includes two omni-directional microphones 12 and 14, that when estimating the DOA of a signal from source S1 will produce two ambiguous DOA estimates of α and 180°—α. The second non-parallel linear array 20 also includes two omni-directional microphones 14 and 26. As illustrated, the second linear array 20 may share microphone 14 with the first linear array 10. Similar to the first linear array 10, the second linear array 20 by itself would produce two ambiguous estimations of the DOA of a signal from source S1 as illustrated in FIG. 2 as an angle β and at an angle 180°—β, as if the signal originated from source S3. Together, however, the non-parallel linear arrays 10 and 20 unambiguously identify the DOA of the signal based on angles α and β, which both indicate that the signal originated from source S1.

Analogously, in a three dimensional DOA case, three non-parallel linear arrays are required to determine the DOA in three dimensions without ambiguity, as using only two non-parallel linear arrays will produce two symmetric solutions

A major drawback of the use of two non-parallel linear arrays in the two dimensional DOA case, however, is that the dimension of the device is greatly increased with respect to a single linear array. For example, in a single headset, illustrated in FIG. 3, a device 30 with two non-parallel linear arrays, includes a portion 32 housing a first linear array arranged pointing to the front of the user and another portion 34 housing the second, non-parallel linear array pointing to the side of the user 36 on perpendicular axes, resulting in a bulky, cumbersome, and unsightly device 30.

### SUMMARY

A linear array of sensors includes at least two omni-directional sensors and at least one directional sensor, with the direction of sensitivity of the directional sensor arranged perpendicular to the axis of the linear array. The omni-directional sensors and directional sensor receive a signal and in response produce output signals. The direction of arrival of the received signal is estimated with a 360° range using the output signals of the omni-directional sensors and directional sensor. For example, two symmetric solutions for the direction of arrival of the received signal may be determined using the output signals of the omni-directional sensors, and the output signal from the directional sensor is used to determine the correct solution.

In one implementation, a method includes receiving a signal with at least two omni-directional sensors and at least one directional sensor arranged in a linear array; generating output signals from the at least two omni-directional sensors and an output signal from the at least one directional sensor in response to the received signal; and using the output signals from the at least two omni-directional sensors and the output signal from the at least one directional sensor to determine a direction of arrival of the received signal with respect to the linear array.

In one implementation, an apparatus includes a linear array of sensors comprising at least two omni-directional sensors and at least one directional sensor, wherein the at least two omni-directional sensors produce output signals and the at least one directional sensor produces an output signal in response to a received signal; and a processor coupled to receive the output signals from the at least two omni-directional sensors and the output signal from the at least one directional sensor, the processor configured to use the output signals from the at least two omni-directional sensors and the output signal from the at least one directional sensor to determine a direction of arrival of the received signal with respect to the linear array of sensors.

In one implementation, an apparatus includes means for receiving a signal at a first location with omni-directional sensitivity and generating a first output signal in response; means for receiving the signal at a second location with omni-directional sensitivity and generating a second output signal in response; means for receiving the signal at a third location with directional sensitivity and generating a third output signal in response, wherein the first location, the second location, and the third location are arranged in a linear array; and means for using the first output signal, the second output signal and the third output signal to determine a direction of arrival of the received signal with respect to the linear array.

In one implementation, a non-transitory computer-readable medium including program code stored thereon, includes program code to receive output signals from at least two omni-directional sensors and an output signal from at least one directional sensor in response to a received signal, wherein the at least two omni-directional sensors and at least one directional sensor are arranged in a linear array; and program code to use the output signals from the at least two omni-directional sensors and the output signal from the at least one directional sensor to determine a direction of arrival of the received signal with respect to the linear array.

### BRIEF DESCRIPTION OF THE DRAWING

FIG. 1 illustrates a conventional linear array of omni-directional microphones that produces ambiguous direction of arrival estimates for a received signal.

FIG. 2 illustrates two, non-parallel, linear arrays of omni-directional microphones that are conventionally used to produce an unambiguous estimate of the direction of arrival estimate for a received signal.

FIG. 3 illustrates the form factor for a conventional device with two non-parallel linear arrays.

FIG. 4 illustrates a linear array that includes omni-directional sensors and at least one directional sensor to estimate the direction of arrival of a received signal over a 360° range in two dimensions.

FIG. 5 illustrates the linear array from FIG. 4 combined with a second non-parallel linear array to estimate the direction of arrival of a received signal in three dimensions.

FIG. 6 illustrates the directionality of an omni-directional sensor as a polar pattern.

FIG. 7 illustrates the directionality of a directional sensor as a polar pattern.

FIG. 8 is a flow chart illustrating the process of estimating the direction of arrival of a received signal over a 360° range using a single linear array.

FIG. 9 is a flow chart illustrating the process of estimating the direction of arrival of a received signal in three dimensions using two non-parallel linear arrays.

FIG. 10 is a block diagram of a device capable of estimating the direction of arrival of a received signal with a 360° range using a single linear array.

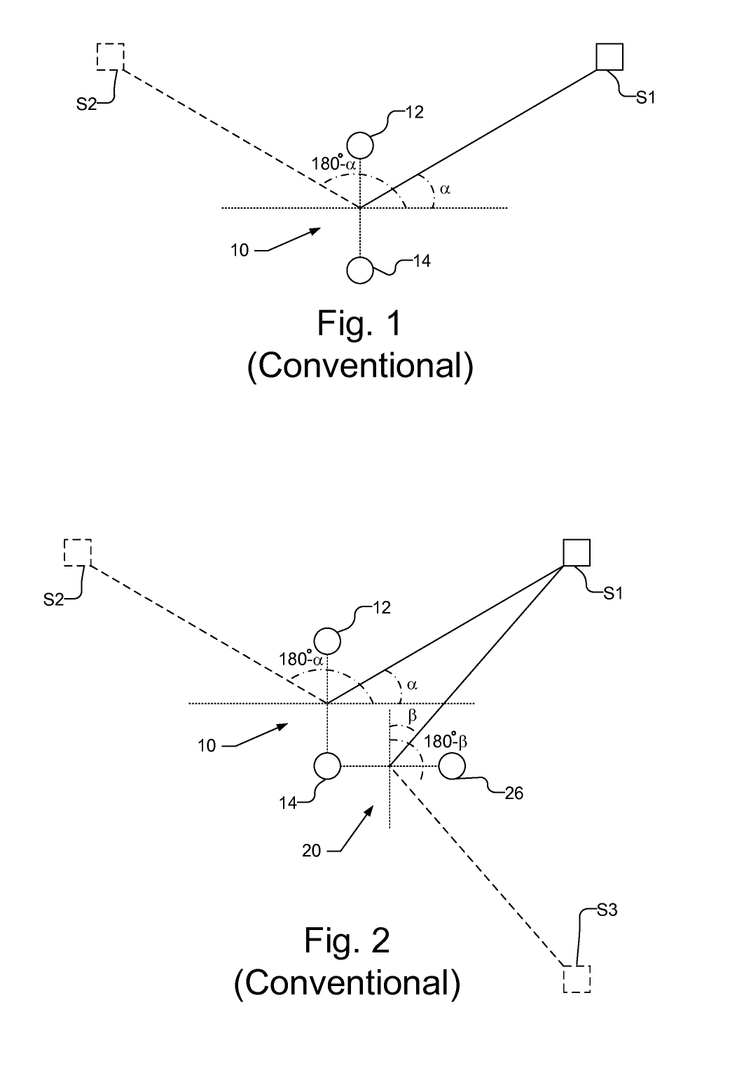

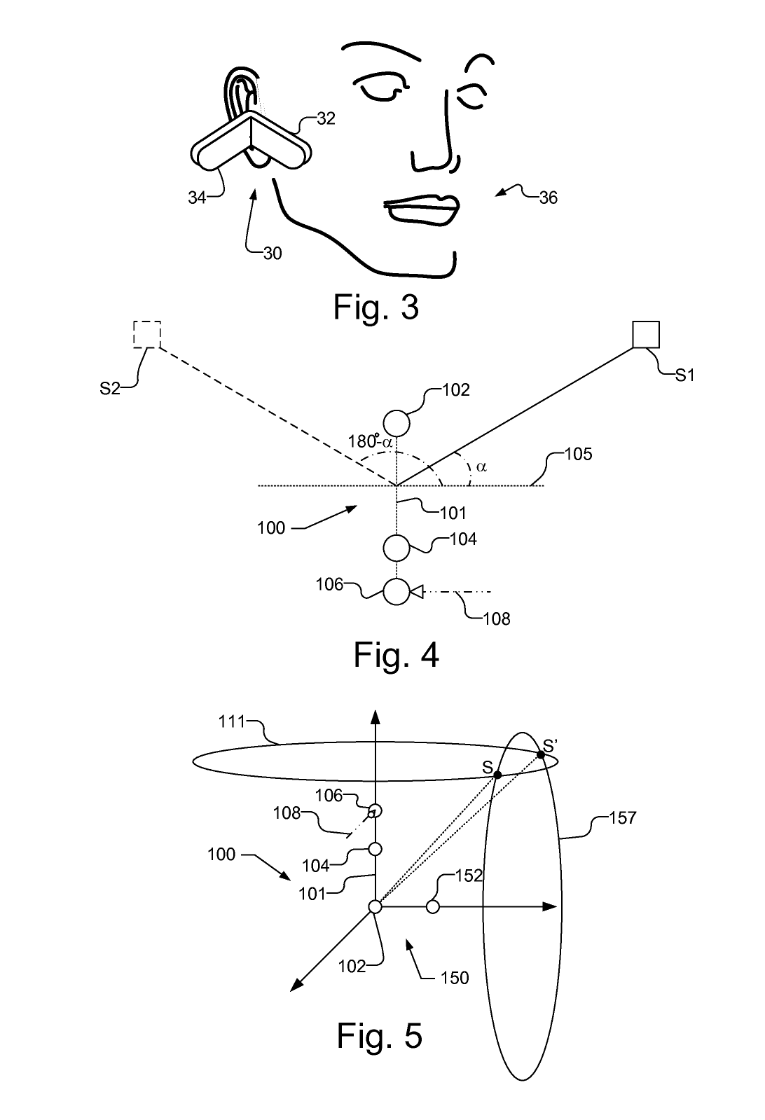

### DETAILED DESCRIPTION

FIG. 4 illustrates a linear array 100 of sensors that may be used to estimate, without ambiguity, the DOA of a received signal in a 360° range in a two dimensional DOA case, i.e., the DOA estimate does not consider elevation. Linear array 100 is illustrated as including two omni-directional sensors 102 and 104 and a third directional sensor 106. If desired, additional omni-directional sensors and additional directional microphones may be included in the linear array 100. Moreover, it should be understood that the sensors 102, 104, and 106 in linear array 100 may be microphones for receiving acoustic signals, or any other desired type of omni-directional and directional sensors may be used, such as sensors for receiving electronic signals or any other type of signals including communication signals and ultrasound.

If desired, the linear array 100 of sensors 100 may be used, along with a second non-parallel linear array of sensors to estimate the DOA of a received signal in three dimensions. By way of example, FIG. 5 illustrates a perspective view of linear array 100 combined with a second non-parallel linear array 150, which includes two omni-directional sensors 102 and 152. The second linear array 150 may be perpendicular to the first linear array 100. The second linear array 150 may share an omni-directional sensor 102 with the first linear array 100 if desired, or use separate omni-directional sensors. The resulting arrangement of linear arrays 100 and 150 is capable of estimating the DOA in three dimensions.

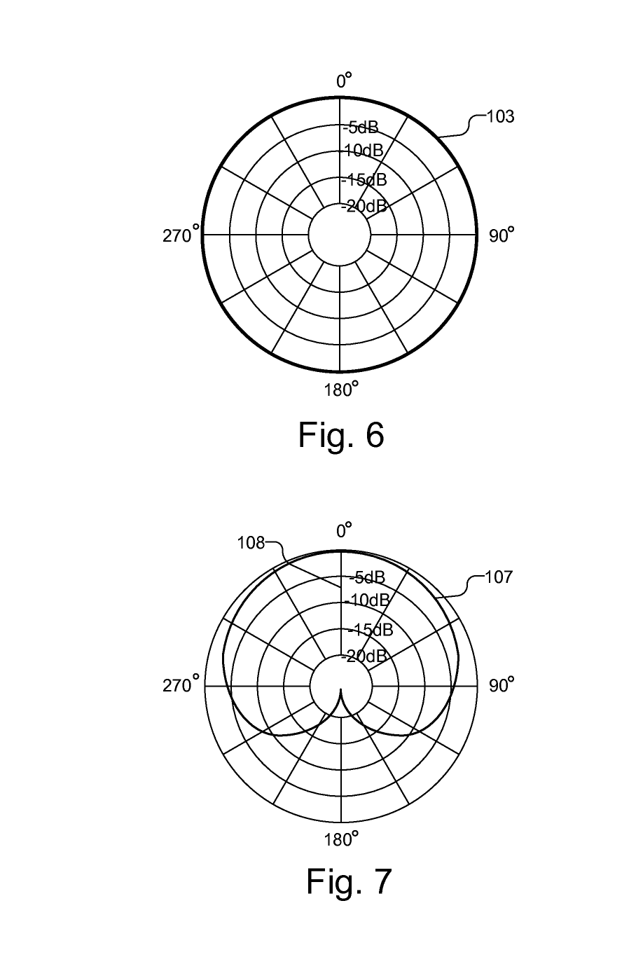

FIG. 6 illustrates, by way of example, the directionality of omni-directional sensors 102 and 104 showing the sensitivity of the omni-directional sensors 102 and 104 to signals arriving at different angles about its central axis. The polar pattern 103 illustrated in FIG. 6 shows the spatial response of a theoretically omni directional sensor. As can be seen in FIG. 6, the sensors 102 and 104 will produce, in theory, the same signal level output for a given power level of the received signal regardless of the direction of arrival of the signal, and sensors 102 and 104 are therefore referred to as omni-directional.

FIG. 7 is similar to FIG. 6, but illustrates an example of the directionality of the directional sensor 106. As can be seen by the polar pattern 107 in FIG. 7, the directional sensor 106 will produce a greater signal level output signal if a received signal arrives along the sensor's axis of sensitivity 108, identified as 0° in FIG. 7. It should be understood that different types of directional sensors may be used as directional sensor 106, and thus, the resulting polar pattern of directional sensor 106 may have different shapes than the polar pattern 107 illustrated in FIG. 7.

As illustrated in FIG. 4, the linear array 100 is configured with an axis of sensitivity 108 of the directional sensor 106 aligned so that it is non-parallel to the linear axis 101 between the sensors in the linear array 100. In one implementation, the axis of sensitivity 108 may be perpendicular to the linear axis 101. It should be understood that a perpendicular arrangement of the axis of sensitivity 108 and the linear axis 101 contemplates slight variation from perpendicular, e.g., based on manufacturing tolerances and/or design, but should be sufficiently close to perpendicular that directional sensor 106 may be reliably used to resolve the ambiguity in possible DOAs produced by the two omni-directional sensors 102 and 104, e.g., ±10° from perpendicular. Thus, in response to signals received from a source S2 to the left of the linear array 100 in FIG. 4, the directional sensor 106 will produce a relatively attenuated response with respect to signals received from the source S1 if located to the right of the linear array 100.

Using the configuration of omni-directional sensors 102, 104 and directional sensor 106 in the linear array 100 illustrated in FIG. 4, the DOA of a signal from source S1 at an angle α may be distinguished from a DOA of a signal from source S2 at an angle 180°—α a based on the resulting output signal from directional sensor 106. The omni-directional sensors 102 and 104 in linear array 100 may use the difference in the time of arrival of the received signal to determine possible DOAs, illustrated in FIG. 4, illustrated at angles α and 180°—α from an axis 105 that is perpendicular to the linear array axis 101 (an in one implementation parallel with the axis of sensitivity 108 of the directional sensor 106). The output signal from the directional sensor 106 may be used to resolve the ambiguity between the possible DOAs. As the response for the directional sensor 106 is less attenuated for signals that are received along or near the axis of sensitivity 108 of the directional sensor 106, the output signal from the directional sensor 106 will be greater if the DOA angle is between ±90° from the axis of sensitivity 108. Thus, for example, by comparing the response of the directional sensor 106 to a received signal with the response from one or more of the omni-directional sensors 102 and 104 to the received signal, it can be determined which of the two possible solutions provided by omni-directional sensors 102 and 104 is correct. Thus, the estimated DOA may be unambiguously determined using the linear array 100.

By way of example, if the response from directional sensor 106 is approximately the same as the response from one of omnidirectional sensors 102 and 104, e.g., within a threshold, then the signal was received approximately along the axis of sensitivity 108 of the directional sensor 106, e.g., between ±90° from the 0° direction (i.e., the axis of sensitivity 108) shown in FIG. 7. On the other hand, if the response from directional sensor 106 is significantly less than the response from one of the omni-directional sensors 102 and 104, e.g., outside a threshold, then the signal was received from a direction that is approximately opposite the axis of sensitivity 108 of the directional sensor 106, e.g., between ±90° from the 180° direction shown in FIG. 7. The relation of the axis of sensitivity 108 of the directional sensor 106 with respect to the linear axis 101 of the linear array 100 is known, and thus, the response of the directional sensor 106 can be used to determine from which side of the linear axis 101 that the signal arrived.

The comparison of the output signal from the directional sensor 106 and the omni-directional sensor 102 may be a power-ratio of the output signals, which may then compared to an appropriate threshold to determine which of the two possible solutions is correct. The directional sensor 106 may be calibrated with respect to at least one of the omni-directional sensors 102 and 104 in order to normalize the output signal from the directional sensor 106. One or more threshold values may be determined using the normalized output signals. For example, a single threshold value, such as 0.80 may be used for comparing the ratio of the response of the directional sensor 106 to the response of the omni-directional sensor. The threshold value may be determined based on a comparison of the specification values for the sensors, e.g., as shown in FIGS. 6 and 7.

If desired, more than one threshold may be used, e.g., multiple thresholds that are a function of angle may be used. For example, the threshold value Thr(θ) may be determined for each angle θ with respect to the axis of sensitivity 108 as follows:

$$Thr ( θ ) = \frac{( \frac{Dx ( θ )}{Ox ( θ )} ) + ( \frac{Dx ( 180 - θ )}{Ox ( 180 - θ )} )}{2} \qquad eq . 1$$

Where Dx(θ) is the response of the directional sensor 106 at the angle θ as provided by the specification values, e.g., as shown in FIGS. 7, and Ox(θ) is the response of an omni-directional sensor 102 or 104 at the angle θ again as provided by the specification values, e.g., as shown in FIG. 6. Other methods of determining threshold values may be used if desired.

Thus, the two omni-directional sensors 102 and 104 may be used to produce two symmetric solutions, with respect to the linear axis 101, for the DOA, illustrated as α and 180°-α in FIG. 4. A comparison, e.g., ratio, of the responses from the directional sensor and an omni-directional sensor 102, is compared to the threshold, which can be used to select the correct solution thereby resolving the ambiguity. For example, if the resulting comparison is less than the threshold, e.g., Dx/Ox<Thr(α), then the correct solution is 180°-α, otherwise, the correct solution is α.

Thus, with one or more directional sensors added to a single linear array of omni-sensors, the coverage range of the estimated DOA is extended from 180° to 360°. With the use of a single linear array of sensors, the physical dimension of the resulting device is relatively small, enabling attractive products, such as headsets. Moreover, the computational load of determining the DOA is reduced compared to the conventional method of using two non-parallel linear arrays.

Additionally, if desired, the DOA may be determined in three-dimensions using two non-parallel linear arrays 100 and 150, as illustrated in FIG. 5. As illustrated in FIG. 5, the first linear array 100 produces an infinite possible solutions for the DOA in three-dimensions, all of which have the same angle with respect to the linear axis 101, illustrated as ring 111. Similarly, infinite possible solutions for the DOA, illustrated as ring 157, are produced by the second linear array 150. The intersection of rings 111 and 157 are, thus, possible sources S and S′, both of which have the same DOA with respect to the linear axis 101 of the first linear array 100 and the same DOA with respect to the linear axis of the second linear array 150. Thus, using the first linear array 100 and the second linear array 150, two possible solutions are produced in three-dimensions. With the use of directional sensor 106, which has its axis of sensitivity 108 out of the plane, i.e., perpendicular to the plane, formed by the first linear array 100 and the second linear array 150, the ambiguity between possible solutions S and S′ may be resolved as discussed above.

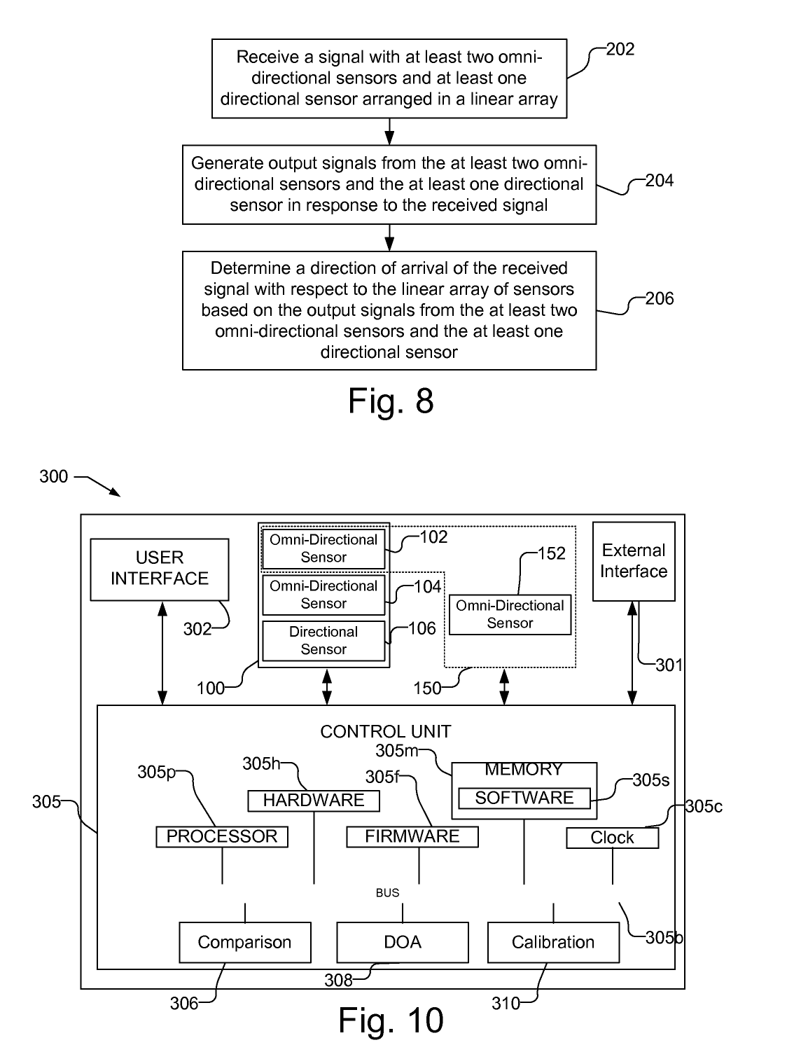

FIG. 8 is a flow chart illustrating the process of estimating the DOA of a received signal with a 360° range using a single linear array. As illustrated, a signal is received with at least two omni-directional sensors and at least one directional sensor arranged in a linear array (202). The at least two omni-directional sensors and at least one directional sensor may be, e.g., microphones or electronic signal sensors. Output signals from the two omni-directional sensors and the at least one directional sensor are generated in response to the received signal (204). The output signals from the at least two omni-directional sensors and the at least one directional sensor are used to determine a direction of arrival of the signal with respect to the linear array of sensors (206). For example, two symmetric solutions for the direction of arrival of the signal may be determined using the at least two omni-directional sensors and the correct solution from the two symmetric solutions may be determined using the at least one directional sensor, e.g., using the power-ratio between received signals at the directional sensor and at least one of the omni-directional sensors. By way of example, an output signal from the directional sensor may be compared to an output signal from at least one of the omni-directional sensor to determine the correct solution. The comparison of the output signal from the directional sensor to the output signal from at least one of the omni-directional sensor may be a ratio of the signals that is then compared to a threshold. The threshold may be a directivity dependent threshold, i.e., it may vary based on the direction of arrival of the signal, e.g., as determined using the two omni-directional sensors. The threshold may be generated based on a ratio of a response from the at least one directional sensor with respect to a response from one of the at least two omni-directional sensors at angles θ and 180°—θ, e.g., as provided by specification values. An initialization process may be used to calibrate the directional sensor by normalizing the received directivity pattern of the directional sensor with respect to the directivity pattern of the omni-directional sensor.

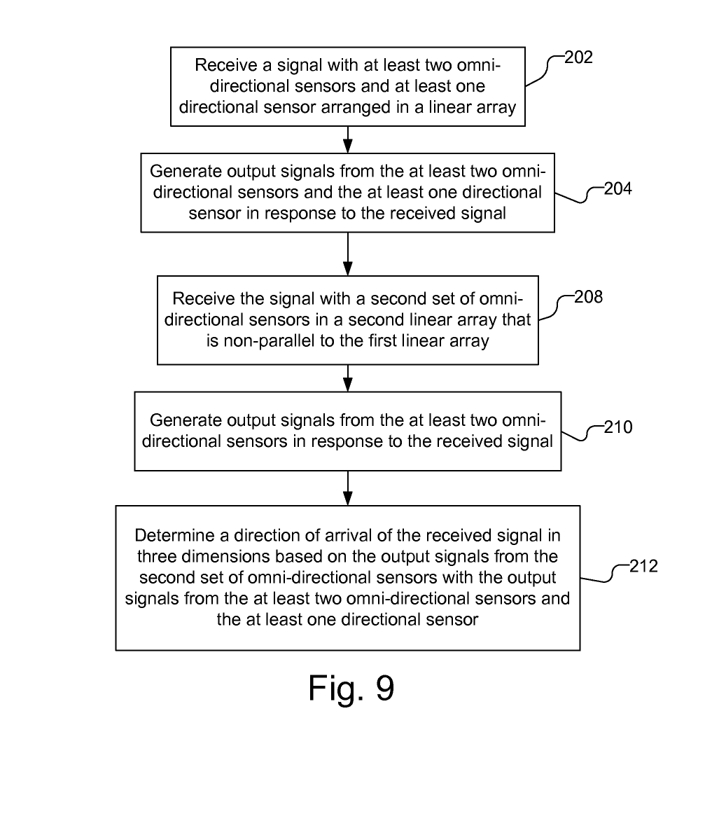

A second linear array may be used to determine the direction of arrival in three dimensions. FIG. 9 is a flow chart illustrating the process of estimating the DOA of a received signal in three dimensions using two non-parallel linear arrays, such as that illustrated in FIG. 5. FIG. 9 is similar to FIG. 8, like designated elements being the same. Additionally, as illustrated, the signal is received with a second set of omni-directional sensors in the second linear array that is non-parallel, e.g., perpendicular, with the first linear array (208). If desired, the second linear array may share one of the omni-directional sensors with the first linear array. Output signals are generated from the second set of omni-directional sensors in response to the received signal (210). The direction of arrival of the received signal is determined in three-dimensions using the output signals from the second set of omni-directional sensors in the second linear array with the output signals from the at least two omni-directional sensors and the output signal from the at least one directional sensor in the first linear array (212). For example, two symmetric solutions for the direction of arrival of the signal may be determined in three-dimensions using the output signals from the second set of omni-directional sensors in the second linear array and the output signals from the at least two omni-directional sensors and the correct solution from the two symmetric solutions may be determined using the at least one directional sensor, e.g., using the power-ratio between received signals at the directional sensor and at least one of the omni-directional sensors, in a manner similar to that discussed above.

FIG. 10 is a block diagram of a device 300 capable of estimating the direction of arrival of a received signal with a 360° range using a single linear array. As illustrated, the device includes a linear array 100 of sensors, including at least two omni-directional sensors 102 and 104, and at least one directional sensor 106 that is disposed along the linear axis and has an axis of sensitivity that is perpendicular to the linear axis, as discussed above. The device 300 may further include a second linear array 150, which has a linear axis that is orthogonal to the linear axis of the first linear array 100, and which includes omni-directional sensor 152 and omni-directional sensor 102, which is shared with the linear array 100. If a second linear array 150 is included, the axis of sensitivity of the at least one directional sensor 106 may be perpendicular to a plane formed by the linear axes of the first linear array 100 and the second linear array 150, as discussed above. The device 300 includes additional elements, such as a user interface 302 that may include e.g., a keypad or other input device through which the user can control the device 300, as well as a display if desired. The device 300 may additionally include an external interface 301 with which the device 300 may communicate with external devices, e.g., to provide the estimated direction of arrival of a received signal, or if desired, to provide data from the linear array 100 with which the external device may determine the estimated direction of arrival.

The external interface 301, by way of example, may be any various wired or wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth® network, an IEEE 802.15x, or some other type of network. Moreover, any combination of WWAN, WLAN and/or WPAN may be used.

The device 300 also includes a control unit 305 that is connected to and communicates with the linear array 100, linear array 150 (if included) as well as the user interface 308 and an external interface 301 (if included). The control unit 305 may be provided by a bus 305b, processor 305p and associated memory 305m, hardware 305h, firmware 305f, and software 305s, and a clock 305c. The control unit 305 receives and processes data obtained from the omni-directional sensors 102, 104, and directional sensor 106 in the linear array 100 to estimate the direction of arrival of a signal, as discussed above. The control unit 305 may also receive and process data obtained from the omni-directional sensors 102 and 152 in the second linear array 150 if used, to estimate the direction of arrival of the signal in three-dimensions, as discussed above. The control unit 305 is illustrated as including a DOA module 308 that may be used to determine the direction of arrival of a signal in the arrival of the signal to the linear array 100, which may produce two ambiguous solutions. The control unit 305 is further illustrated as including a comparison module 306 that compares the output signal from the directional sensor 106 to one or more of the omni-directional sensors 102 and 104, which is compared to a threshold and used by the DOA module 308 to resolve the ambiguity of the solutions. If the second linear array 150 is used, the DOA module 308 and comparison module 306 may be used to determine an unambiguous solution in three-dimensions, e.g., by combining the ambiguous solutions derived from the first linear array 100 and the ambiguous solutions derived from the second linear array 150 to produce two ambiguous solutions, wherein the comparison module 306 may compare the output signal from the directional sensor 106 to one or more of the omni-directional sensors 102 and 104, which is compared to a threshold and used by the DOA module 308 to resolve the ambiguity of the solutions. A calibration module 310 may be used to calibrate the directional sensor 106 with respect to one or more of the omni-directional sensors 102, 104, including normalizing a directivity pattern of the directional sensor 106 with respect to one or more of the omni-directional sensors 102, 104 and for determining a threshold value or directivity depended threshold values used by comparison module 306. The threshold value or values may be stored, e.g., in memory 305m or other appropriate storage element in device 300.

The comparison module 306, the DOA module 308, and calibration module 310 are illustrated separately from processor 305p for clarity, but may be part of the processor 305p or implemented in the processor based on instructions in the software 305s which is run in the processor 305p. It will be understood as used herein that the processor 305p can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The methodologies described herein may be implemented by various means depending upon the application. For example, these methodologies may be implemented in hardware 305h, firmware 305f, software 305s, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 305m and executed by the processor 305p. Memory 305m may be implemented within or external to the processor 305p. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Thus, the device 300 includes a means for means for receiving a signal at a first location with omni-directional sensitivity and generating a first output signal in response and a means for receiving the signal at a second location with omni-directional sensitivity and generating a second output signal in response, which may be, e.g., omni-directional sensors 102 and 104. A means for receiving the signal at a third location with directional sensitivity and generating a third output signal in response may be the directional sensor 106. The first location, the second location, and the third location are arranged in a linear array 100. A means for using the first output signal, the second output signal and the third output signal to determine a direction of arrival of the received signal with respect to the linear array may be, e.g., the control unit 305, which may include hardware 305h, firmware 305f and/or processor 305p using program code stored in memory 305m and specifically may use the comparison module 306, and DOA module 308. A means for determining two symmetric solutions for the direction of arrival of the signal using the first output signal and the second output signal may be the DOA module 308. A means for determining a correct solution from the two symmetric solutions for the direction of arrival of the signal using the third output signal may be, e.g., the DOA module 308 using the output of the comparison module 306. A means for comparing the third output signal to at least one of the first output signal and the second output signal to determine a comparison value and to compare the comparison value to a threshold to determine the correct solution may be, e.g., the comparison module 306. A means for calibrating the means for receiving the signal at the third location with directional sensitivity with respect to the means for receiving the signal at the second location with omni-directional sensitivity may be, e.g., the calibration module 310 and/or processor 305p using program code stored in memory 305m. A means for determining a direction of arrival of the received signal in three-dimensions may be, e.g., the second linear array 150, as well as the DOA module 308 using the output of the comparison module 306.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
receiving a signal with at least two omni-directional sensors and at least one directional sensor arranged in a linear array;
generating output signals from the at least two omni-directional sensors and an output signal from the at least one directional sensor in response to the received signal; and
using the output signals from the at least two omni-directional sensors and the output signal from the at least one directional sensor to determine a direction of arrival of the received signal with respect to the linear array.

2. The method of claim 1, wherein using the output signals from the at least two omni-directional sensors and the output signal from the at least one directional sensor comprises:
determining two symmetric solutions for the direction of arrival of the signal using the output signals from the at least two omni-directional sensors; and
determining a correct solution from the two symmetric solutions for the direction of arrival of the signal using the output signal from the at least one directional sensor.

3. The method of claim 2, using the output signal from the at least one directional sensor comprises:
comparing the output signal from the at least one directional sensor to at least one of the output signals from the at least two omni-directional sensors to produce a comparison value;
comparing the comparison value to a threshold to determine the correct solution.

4. The method of claim 3, wherein the threshold is directivity dependent.

5. The method of claim 1, further comprising:
calibrating the at least one directional sensor with respect to at least one of the at least two omni-directional sensors.

6. The method of claim 5, wherein calibrating the at least one directional sensor comprises normalizing of a directivity response of the at least one direction sensor with respect to the at least one of the at least two omni-directional sensors.

7. The method of claim 1, further comprising
generating a directivity dependent threshold based on a ratio of a response from the at least one directional sensor with respect to a response from one of the at least two omni-directional sensors.

8. The method of claim 1, wherein the at least two omni-directional sensors and the at least one directional sensor are selected from one of microphones and electronic signal sensors.

9. The method of claim 1, wherein the linear array is a first linear array, the method further comprising:
receiving the signal with a second set of omni-directional sensors in a second linear array that is non-parallel with the first linear array;
generating output signals from the second set of omni-directional sensors in response to the received signal; and
using the output signals from the second set of omni-directional sensors in the second linear array with the output signals from the at least two omni-directional sensors and the output signal from the at least one directional sensor in the first linear array to determine a direction of arrival of the received signal in three-dimensions.

10. An apparatus comprising:
a linear array of sensors comprising at least two omni-directional sensors and at least one directional sensor, wherein the at least two omni-directional sensors produce output signals and the at least one directional sensor produces an output signal in response to a received signal; and
a processor coupled to receive the output signals from the at least two omni-directional sensors and the output signal from the at least one directional sensor, the processor configured to use the output signals from the at least two omni-directional sensors and the output signal from the at least one directional sensor to determine a direction of arrival of the received signal with respect to the linear array of sensors.

11. The apparatus of claim 10, wherein the processor is configured to use the output signals from the at least two omni-directional sensors and the output signal from the at least one directional sensor by being configured to determine two symmetric solutions for the direction of arrival of the signal using the output signals from the at least two omni-directional sensors; and determine a correct solution from the two symmetric solutions for the direction of arrival of the signal using the output signal from the at least one directional sensor.

12. The apparatus of claim 11, wherein the processor is configured to determine the correct solution from the two symmetric solutions for the direction of arrival of the signal using the output signal from the at least one directional sensor by being configured to compare the output signal from the at least one directional sensor to at least one of the output signals from the at least two omni-directional sensors to produce a comparison value and to compare the comparison value to a threshold to determine the correct solution.

13. The apparatus of claim 12, wherein the threshold is directivity dependent.

14. The apparatus of claim 10, wherein the at least one directional sensor is calibrated with respect to at least one of the at least two omni-directional sensors.

15. The apparatus of claim 14, wherein the at least one directional sensor is calibrated by normalizing the directivity response of the at least one directional sensor with respect to at least one of the at least two omni-directional sensors.

16. The apparatus of claim 10, wherein the at least two omni-directional sensors and the at least one directional sensor are selected from one of microphones and electronic signal sensors.

17. The apparatus of claim 10, further comprising:
a second linear array of sensors comprising a second set of omni-directional sensors, the second linear array is non-parallel to the first linear array;
wherein the processor is coupled to receive output signals from the second set of omni-directional sensors from the second directional sensor, the processor being further configured to use the output signals from the second linear array with the output signals from at least two omni-directional sensors and the output signal from the at least one directional sensor to determine a direction of arrival of the received signal in three-dimensions.

18. An apparatus comprising:
means for receiving a signal at a first location with omni-directional sensitivity and generating a first output signal in response;
means for receiving the signal at a second location with omni-directional sensitivity and generating a second output signal in response;
means for receiving the signal at a third location with directional sensitivity and generating a third output signal in response, wherein the first location, the second location, and the third location are arranged in a linear array; and
means for using the first output signal, the second output signal and the third output signal to determine an unambiguous direction of arrival of the received signal with respect to the linear array.

19. The apparatus of claim 18, wherein the means for using comprises means for determining two symmetric solutions for the direction of arrival of the signal using the first output signal and the second output signal; and means for determining a correct solution from the two symmetric solutions for the direction of arrival of the signal using the third output signal.

20. The apparatus of claim 19, wherein the means for using further comprises means for comparing the third output signal to at least one of the first output signal and the second output signal to determine a comparison value and to compare the comparison value to a threshold to determine the correct solution.

21. The apparatus of claim 20, wherein the threshold is directivity dependent.

22. The apparatus of claim 18, further comprising:
means for calibrating the means for receiving the signal at the third location with respect to the means for receiving the signal at the second location.

23. The apparatus of claim 18, further comprising:
means for determining a direction of arrival of the received signal in three-dimensions.

24. A non-transitory computer-readable medium including program code stored thereon, comprising:
program code to receive output signals from at least two omni-directional sensors and an output signal from at least one directional sensor in response to a received signal, wherein the at least two omni-directional sensors and the at least one directional sensor are arranged in a linear array; and
program code to use the output signals from the at least two omni-directional sensors and the output signal from the at least one directional sensor to determine a direction of arrival of the received signal with respect to the linear array.

25. The non-transitory computer-readable medium of claim 24, wherein the program code to use the output signals from the at least two omni-directional sensors and the output signal from the at least one directional sensor comprises:
program code to determine two symmetric solutions for the direction of arrival of the signal using the output signals from the at least two omni-directional sensors; and
program code to determine a correct solution from the two symmetric solutions for the direction of arrival of the signal using the output signal from the at least one directional sensor.

26. The non-transitory computer-readable medium of claim 25, wherein the program code to determine the correct solution from the two symmetric solutions for the direction of arrival of the signal using the output signal from the at least one directional sensor comprises:
program code to compare the output signal from the at least one directional sensor to at least one of the output signals from the at least two omni-directional sensors to determine a comparison value; and
program code to compare the comparison value to a threshold to determine the correct solution.

27. The non-transitory computer-readable medium of claim 24, further comprising:
program code to calibrate the at least one directional sensor with respect to at least one of the at least two omni-directional sensors.

28. The non-transitory computer-readable medium of claim 27, wherein the program code to calibrate the at least one directional sensor comprises program code to normalize a received directivity pattern with respect to the at least one of the at least two omni-directional sensors.

29. The non-transitory computer-readable medium of claim 27, wherein the linear array is a first linear array, the method further comprising:
program code to receive the signal with a second set of omni-directional sensors in a second linear array that is non-parallel with the first linear array;
program code to generate output signals from the second set of omni-directional sensors in response to the received signal; and
program code to use the output signals from the second set of omni-directional sensors in the second linear array with the output signals from the at least two omni-directional sensors and the output signal from the at least one directional sensor in the first linear array to determine a direction of arrival of the received signal in three-dimensions.
